(19) United States
(12) Patent Application Publication
(10) Pub. No.: US 2006/0274495 A1
(43) Pub. Date: Dec. 7, 2006

(54) Supporting device having cable extending between two housings

(76) Inventors: Hiroshi Nakamura, Ome-shi (JP); Satoshi Araki, Tokyo (JP); Shinichi Kido, Ome-shi (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/454,381

(22) Filed: Jun. 15, 2006

Related U.S. Application Data
(63) Continuation of application No. PCT/JP04/18726, filed on Dec. 15, 2004.

(30) Foreign Application Priority Data
Dec. 17, 2003 (JP) 2003-419464

(51) Int. Cl. G06F 1/16

(52) U.S. Cl. 361/686

(57) ABSTRACT

According to one embodiment, a supporting device has a first housing and a second housing, which overlies the first housing. The first housing and the second housing are connected via a hinge shaft rotatably relative to each other. A cable passes through a connecting portion between the first housing and the second housing. The first housing and the second housing respectively have through holes, which communicate with each other at a position aside from the hinge shaft. The cable passes through the through holes across the first housing and the second housing.

### CROSS-REFERENCE TO RELATED APPLICATIONS

This is a Continuation Application of PCT Application No. PCT/JP2004/018726, filed Dec. 15, 2004, which was published under PCT Article 21(2) in Japanese.

This application is based upon and claims the benefit of priority from Japanese Patent Application No. 2003-419464, filed Dec. 17, 2003, the entire contents of which are incorporated herein by reference.

### BACKGROUND

1. Field

One embodiment of the invention relates to a supporting device for use in connecting an electronic apparatus, such as a portable computer, to external equipments.

2. Description of the Related Art

An electronic apparatus like a portable computer is designed to have a thin and compact housing to facilitate convenience in portability. Accordingly, it is impossible to provide sufficient space, inside the housing, for a plurality of connectors to be connected to external equipments, a multi-drive, or the like.

The portable computer, attaching importance to the portability, is mounted with an expansion connector. The expansion connector is used to connect the portable computer to an expansion apparatus called a docking station. The use of the expansion apparatus allows the portable computer to perform the functions equivalent to those of a desktop computer.

A conventional expansion apparatus comprises a tray, which removably supports a portable computer, and a cable dock having a plurality of auxiliary connectors to be connected to various external equipments. The tray and the cable dock are electrically connected to each other by a cable. Therefore, when the portable computer is placed on the tray, signal paths, such as data buses for transmitting logic addresses and various control signals of the portable computer and the cable dock, are electrically connected to each other via the cable. For example, U.S. Pat. No. 6,407,914B1 discloses such an expansion apparatus.

To enhance the usability of the expansion apparatus, it is preferable that the direction of the display screen of the portable computer be changed 90 degrees in the state where the portable computer is put on the tray. For this purpose, the tray has a turntable, which accepts the portable computer, and a base, which supports the turntable. The turntable has a relay connector, to which the portable computer is connected. It is rotatably connected to the base via a hinge shaft. The relay connector is electrically connected to the cable dock through the cable.

When the turntable is rotated and the movement of the turntable is transmitted to the cable, the cable is twisted. To avoid the twist, it is necessary that the cable be passed through a connecting portion between, for example, the turntable and the base, in such a manner that the movement of the turntable may not be transmitted to the cable.

Jpn. Pat. Appln. KOKAI Publication No. 10-55227 discloses an electronic apparatus, in which a cable is inserted through a connecting portion between two housings. The electronic apparatus has a hollow hinge shaft, which rotatably connects the housings, and the cable is inserted through a space inside the hinge shaft.

In this electronic apparatus, the hinge shaft connecting the two housings extends in the thickness direction of the housings. Therefore, the cable passing through the space inside the hinge shaft is led out through open ends of the hinge shaft, introduced into the insides of the housings, and bent in a direction crossing the hinge shaft at the open ends of the hinge shaft.

The above structure requires a sufficient space for the cable to bent between each of the open ends of the hinge shaft and the inner surface of the housing. The cable used in the expansion apparatus disclosed in the aforementioned U.S. patent is thick and stiff, since it is formed of a bundle of many signal lines. Therefore, it is difficult to bend the cable at right angles, and the bend radius of the cable must be set to a large value.

Therefore, if the routing of the cable disclosed in the above Japanese publication is applied to the tray having the turntable, the cable with a large bend radius will project from the open ends of the hinge shaft to the insides of the turntable and the base. As a result, a large space is required in the turntable and the base along the axial direction of the hinge shaft. Thus, the tray is inevitably thick.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a perspective view of an exemplary expansion device according to an embodiment of the present invention, which shows a state where a docking tray and a docking base are separated from each other;

FIG. 2 is an exemplary perspective view of the expansion device according to the embodiment of the present invention, which shows a state where the docking tray is attached to the docking base;

FIG. 3 is an exemplary perspective view of the expansion device according to the embodiment of the present invention, which shows a state where a portable computer is placed on the docking tray attached to the docking base;

FIG. 4 is an exemplary perspective view of the docking tray according to the embodiment of the present invention;

FIG. 5 is an exemplary sectional view of the docking tray showing a coupling structure coupling the base and a turntable, according to the embodiment of the present invention;

FIG. 6 is an exemplary plan view of the docking tray showing routing of a cable, according to the embodiment of the present invention;

FIG. 7 is an exemplary sectional view of the cable according to the embodiment of the present invention; and

FIG. 8 is an exemplary sectional view showing routing of the cable inside the docking tray, according to the embodiment of the present invention.

### DETAILED DESCRIPTION

Various embodiments according to the invention will be described hereinafter with reference to the accompanying drawings. In general, according to one embodiment of the invention, a supporting device comprises a first housing and a second housing, which overlies the first housing. The first housing and the second housing are connected via a hinge shaft rotatably relative to each other. A cable passes through a connecting portion between the first housing and the second housing. The first housing and the second housing respectively have through holes, which communicate with each other at a position aside from the hinge shaft. The cable passes through the through holes across the first housing and the second housing.

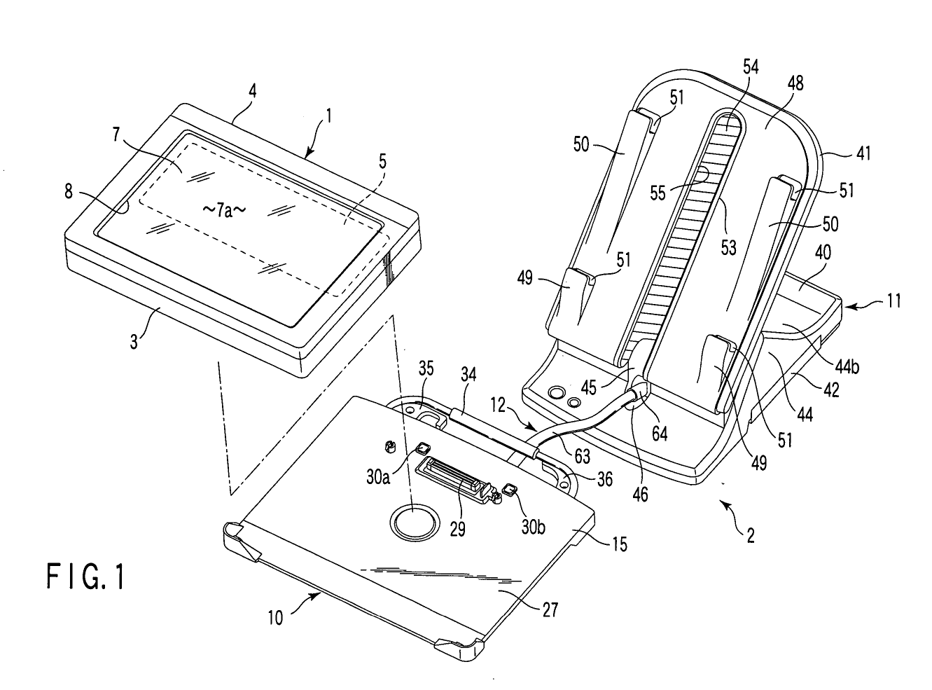

FIG. 1 shows a portable computer 1, as an example of electronic apparatuses, and an expansion device 2 for use in expanding the functions of the portable computer 1.

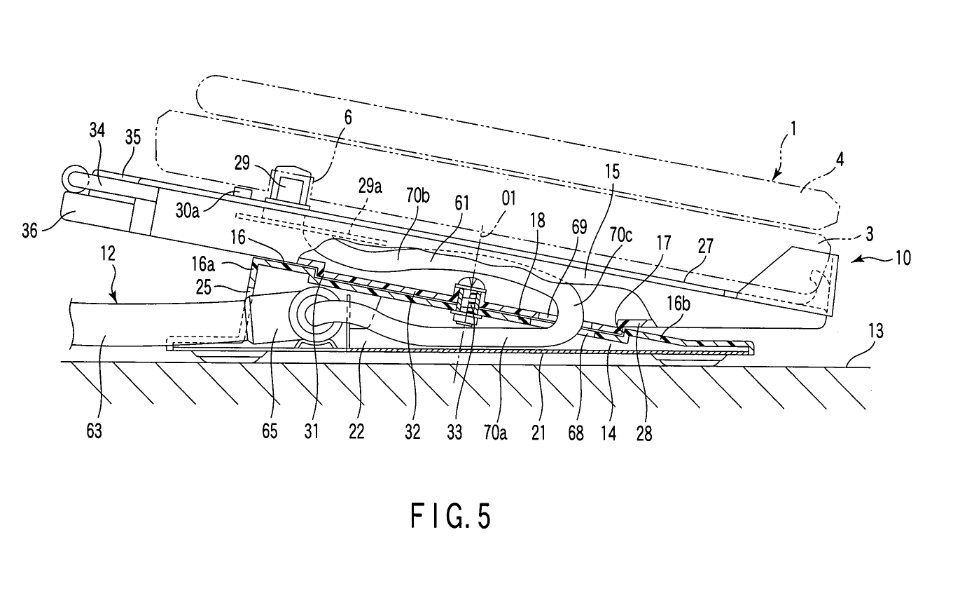

The portable computer 1 comprises a main unit 3 and a display unit 4. The main unit 3 contains primary structural elements, such as a CPU and a hard disk drive, which are not shown. The main unit 3 has a keyboard 5 on the upper surface thereof and an expansion connector 6 as shown in FIG. 5 on the bottom surface thereof.

The display unit 4 contains a tablet 7. The tablet 7 has an input surface 7a to execute an input operation using a tablet pen. The input surface 7a is exposed to the outside of the display unit 4 through an opening 8 formed in the front surface of the display unit 4.

The display unit 4 is coupled to the main unit 3 via a hinge (not shown). The display unit 4 is rotatable between an open position in which it stands so as to expose the keyboard 5 and a closed position in which it flattens to cover the keyboard 5 from above. Further, the display unit 4 is rotatable 180 degrees about the vertical axis in the open position.

When the display unit 4 is rotated 180 degrees in the open position and then rotated to the closed position, it lies over the main unit 3 with the input surface 7a directed upward. In this posture, the portable computer 1 is set to a pen-based input mode.

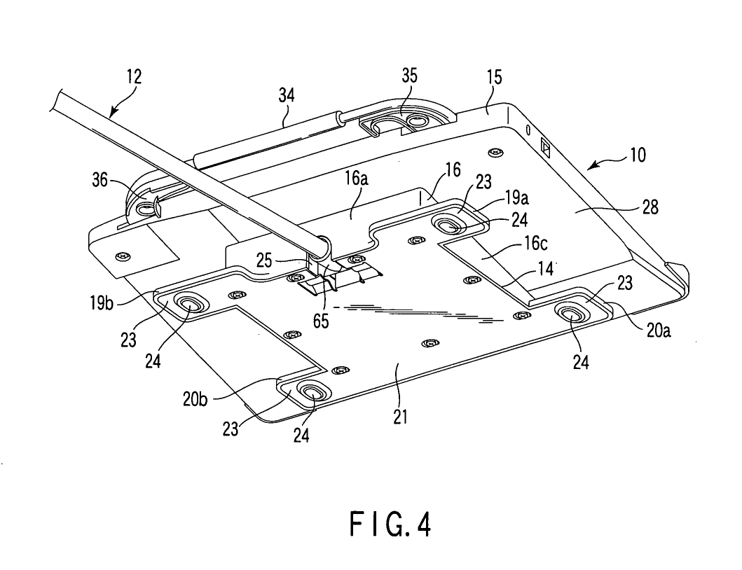

The expansion device 2 comprises a docking tray 10 as an example of the supporting device, a docking base 11 and a flexible cable 12. As shown in FIGS. 4 and 5, the docking tray 10 comprises a base 14 as a first housing and a turntable 15 as a second housing.

The base 14 is placed on a horizontal mount surface 13, such as the top of a desk. It has a table support portion 16 made of synthetic resin. The table support portion 16 is a flat rectangular box, which opens downward and has a back wall 16a, an upper wall 16b, and left and right side walls 16c. The upper wall 16b of the table support portion 16 is inclined down toward the front portion of the docking tray 10. A circular recess portion 17 is formed in a central portion of the upper surface of the upper wall 16b. The bottom of the recess portion 17 forms a first support wall 18.

As shown in FIG. 4, a pair of first engaging portions 19a and 19b is formed in corner portions defined by the back wall 16a and the left and right side walls 16c of the table support portion 16. The first engaging portions 19a and 19b are shaped as flanges and project sideways from the side walls 16c. A pair of second engaging portions 20a and 20b is formed in front end portions of the table support portion 16. The second engaging portions 20a and 20b are shaped as flanges and project sideways from the side walls 16c. The first and second engaging portions 19a, 19b, 20a and 20b are respectively located at the four corner portions of the table support portion 16.

The lower end of the table support portion 16 is covered by a bottom plate 21 made of metal. The bottom plate 21 has four tongue portions 23. The tongue portions 23 are overlaid respectively with the first and second engaging portions 19a, 19b, 20a and 20b of the table support portion 16. Rubber legs 24, which are to be in contact with the mount surface 13, are respectively formed on the tongue portions 23.

The base 4 has a cable holding chamber 22 in the inside thereof. The cable holding chamber 22 is formed between the bottom plate 21 and the table support portion 16. A first cable connection port 25 is formed in a back end portion of the table support portion 16. The first cable connection port 25 is situated at a corner portion defined by the back wall 16a and the bottom plate 21, and open to the cable holding chamber 22.

As shown in FIGS. 1 and 5, the turntable 15 is a flat rectangular box having a size corresponding to the main unit 3 of the portable computer 1. The turntable 15 has a flat mount surface 27 on which the main unit 3 is removably mounted, and a bottom wall 28 opposing to the mount surface 27. A relay connector 29 and a pair of eject members 30a and 30b are located in a central portion of the mount surface 27. The relay connector 29 is supported by a connector board 29a held in the turntable 15. The relay connector 29 is removably connected to the expansion connector 6 of the main unit 3 of the portable computer 1, when the main unit 3 is mounted on the mount surface 27.

The eject members 30a and 30b function to push out the main unit 3 from the mount surface 27. The eject members 30a and 30b are separated from each other in the width direction of the main unit 3. The relay connector 29 is situated between the eject members 30a and 30b. The eject members 30a and 30b are supported by the turntable 15 so as to be movable between a standby position in which they are slightly projected from the mount surface 27 and an eject position in which they are largely projected from the mount surface 27. The eject members 30a and 30b are normally held at the standby position.

When the eject members 30a and 30b are moved from the standby position to the eject position in a state where the main unit 3 is placed on the mount surface 27, the eject members 30a and 30b are caused to push the bottom surface of the main unit 3. Accordingly, the main unit 3 is pushed away from the mount surface 27, so that the connection between the expansion connector 6 and the relay connector 29 is released.

As shown in FIG. 5, the bottom wall 28 of the turntable 15 faces the upper wall 16b of the table support portion 16. A circular projection 31 is formed in a central portion of the bottom surface 28 of the turntable 15. The projection 31 is fitted in the recess portion 17 of the table support portion 16. The projection end of the projection 31 forms a flat second support wall 32. The second support wall 32 is overlain on the first support wall 18 on the bottom of the recess portion 17.

The turntable 15 is rotatably coupled to the table support portion 16 via a screw 33 as a hinge shaft. The screw 33 extends across the second support wall 32 of the turntable 15 and the first support wall 18 of the table support portion 16. Further, the screw 33 is coaxial with the projection 31 and the recess portion 17. The turntable 15 is rotatable 90 degrees about the screw 33.

In other words, the turntable 15 is rotatable between a first rotation position and a second rotation position. In the first rotation position, when the portable computer 1 in the pen-based input mode is mounted on the mount surface 27, for example, the input surface 7a of the portable computer 1 is in a landscape configuration. In the second rotation position, when the portable computer 1 in the pen-based input mode is mounted on the mount surface 27, the input surface 7a of the portable computer 1 is in a portrait configuration. The turntable 15 is locked by a lock mechanism (not shown) at the first rotation position and the second rotation position.

A handle bar 34 for conveyance is attached to one end portion of the turntable 15. The handle bar 34 is substantially parallel to one side of the turntable 15. An eject lever 35 and a lock release lever 36 are arranged in a region surrounded by the handle bar 34 and the side of the turntable 15. The eject lever 35 is located at one end of the handle bar 34. The lock release lever 36 is located at the other end of the handle bar 34.

The eject lever 35 operates in association with the eject members 30a and 30b on the mount surface 27. The eject members 30a and 30b are moved from the standby position to the eject position by operating the eject lever 35. The lock release lever 36 operates in association with the lock mechanism of the turntable 15. The lock of the turntable 15 is released by operating the lock release lever 36.

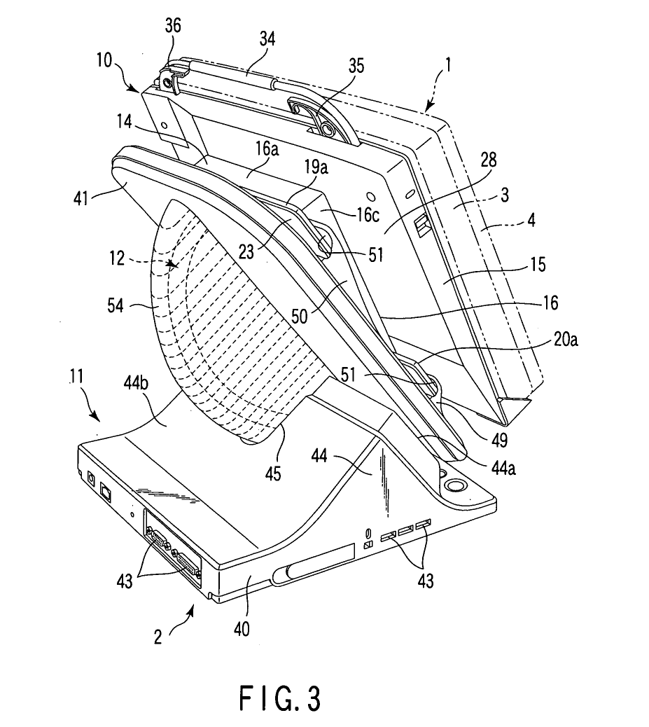

As shown in FIGS. 1 and 3, the docking base 11 comprises a main body 40 to be placed on the mount surface 13, and a tray-supporting portion 41 coupled to the main body 40. The main body 40 contains a multi-drive 42, integrally formed of, for example, a CD-ROM drive and a DVD-ROM drive. Further, the main body 40 is equipped with a plurality of connectors 43, such as PS2, serial, parallel and USB connectors. The connectors 43 are used to connect with peripheral equipments, for example, a floppy disk drive and a printer. They are arranged on the back and side surfaces of the main body 40.

The main body 40 comprises a projection 44 projecting upward. The projection 44 has a front surface 44a and a back surface 44b. The front surface 44a is inclined down toward the front end of the main body 40. The back surface 44b is inclined down toward the back end of the main body 40. Thus, the projection 44 tapers off to a point above the main body 40.

A slit 45 is formed on top of the projection 44. The slit 45 is located in the middle along the width direction of the main body 40, and extends in the depth direction of the main body 40. The slit 45 is opened in the front surface 44a and the back surface 44b of the projection 44.

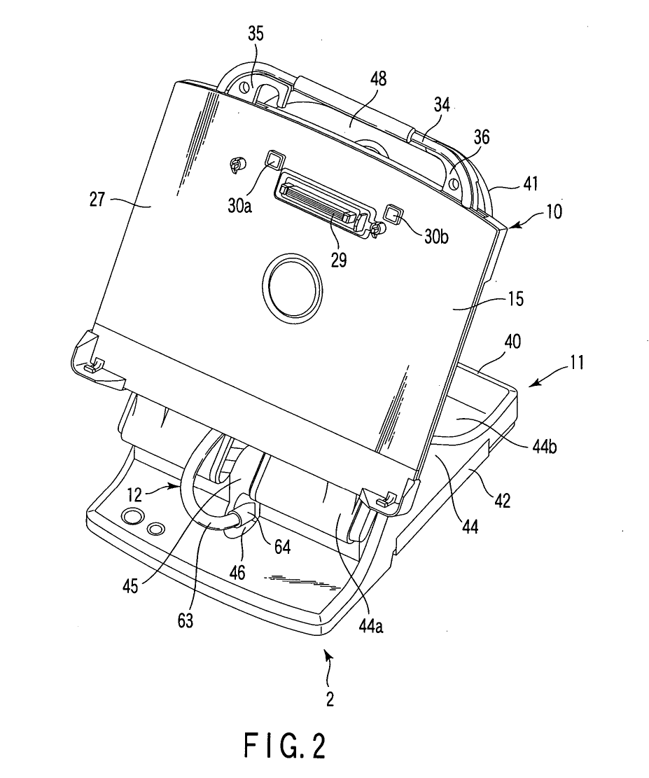

As shown in FIG. 2, a second cable connection port 46 is formed in a central portion of the front surface 44a of the projection 44. The second cable connection port 46 is open to the inside of the main body 40 and located at a front end portion of the slit 45.

As shown in FIGS. 2 and 3, the tray-supporting portion 41 removably supports the docking tray 10 and has a shape of a flat hollow box. The tray-supporting portion 41 stands above the main body 40. A lower end portion of the tray-supporting portion 41 is coupled to a front end portion of the projection 44 via a hinge shaft (not shown).

The tray-supporting portion 41 has a front surface 48, which receives the base 14 of the docking tray 10. The front surface 48 is wider than the base 14. A pair of tray receivers 49 and 50 is formed on each of left and right side portions of the front surface 48. The tray receivers 49 and 50 on each side are separated from each other along the height direction of the front surface 48. Each of the tray receivers 49 and 50 is projected from the front surface 48 so as to incline down toward the lower end of the front surface 48. An engaging groove 51, which opens upward, is formed on the upper end of each of the tray receivers 49 and 50.

FIGS. 2 and 3 show a state where the docking tray 10 is mounted on the front surface 48 of the tray-supporting portion 41. When the docking tray 10 is slid over the front surface 48 in the direction from top to bottom of the tray-supporting portion 41, it is coupled with the tray-supporting portion 41. More specifically, the first and second engaging portions 19a, 19b, 20a and 20b at the four corner portions of the base 14 are engaged with the engaging grooves 51 at the top ends of the tray receivers 49 and 50.

As a result, the docking tray 10 is removably supported by the tray-supporting portion 41 by the first and second engaging portions 19a, 19b, 20a and 20b, and the rubber legs 24 at the four corners of the base 14 are in contact with the front surface 48.

As shown in FIG. 1, a slit-shaped opening 53 is formed in a central portion of the front surface 48 of the tray-supporting portion 41. The opening 53 extends in the height direction of the tray-supporting portion 41. The lower end of the opening 53 is open at the lower end of the tray-supporting portion 41. The second cable connection port 46 is located just under the lower end of the opening 53.

A cable holder 54 is attached to the tray-supporting portion 41. The cable holder 54 is made of, for example, transparent polycarbonate resin. It has a shape of a flat box having a cable introducing port 55 at one end. The cable holder 54 is located within the opening 53 of the tray-supporting portion 41 and projects backward from the tray-supporting portion 41. A lower end portion of the cable holder 54 is inserted in the slit 45 of the main body 40. Further, the cable introducing port 55 of the cable holder 54 is open in the front surface 48 of the tray-supporting portion 41.

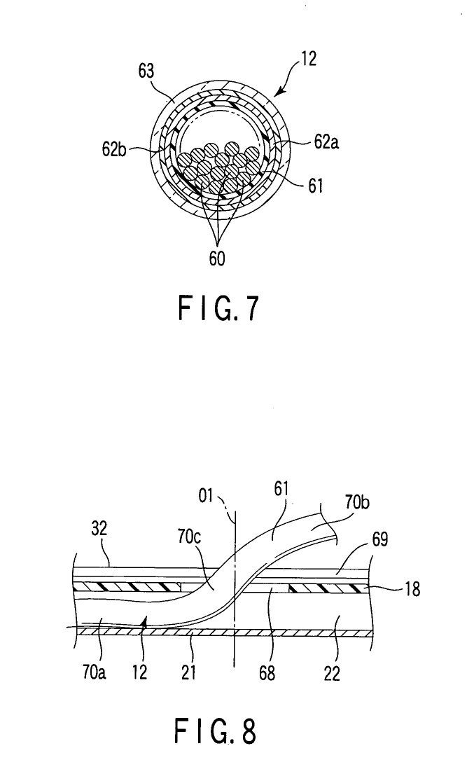

The cable 12 extends across the docking tray 10 and the docking base 11. As shown in FIG. 7, the cable 12 comprises a plurality of signal lines 60, an insulating layer 61, an inner shield layer 62a, an outer shield layer 62b and a protecting tube 63.

The signal lines 60 electrically connect a connector board 29a of the docking tray 10 to the multi-drive 42 and the connectors 43 of the docking base 11. The insulating layer 61 covers the signal lines 60, thereby binding them into one. The inner shield layer 62a and the outer shield layer 62b doubly cover the insulating layer 61 from outside. The protecting tube 63 is made of transparent synthetic resin and covers the outer shield layer 62b. Thus, the cable 12 of this embodiment is about 10 mm thick.

As shown in FIG. 1, one end of the cable 12 is introduced into the main body 40 through the second cable connection port 46. A portion of the cable 12, which is introduced in the main body 40, is not covered by the inner shield layer 62a, the outer shield layer 62b and the protecting tube 63. Therefore, the signal lines 60 bundled by the insulating layer 61 are exposed in the inside of the main body 40.

A cable guide 64 is provided at the second cable connection port 46. The cable guide 64 guides the cable 12 led out through the second cable connection port 46. The cable guide 64 is rotatably supported by the main body 40 of the docking base 11. The cable 12 passes through the cable guide 64.

As shown in FIGS. 4 and 5, the other end of the cable 12 is introduced into the cable holding chamber 22 inside the base 14 through the first cable connection port 25, and further into the inside of the turntable 15 through a connecting portion between the base 14 and the turntable 15. A portion of the cable 12, which is introduced in the base 14 and the turntable 15, is not covered by the inner shield layer 62a, the outer shield layer 62b and the protecting tube 63. Therefore, the signal lines 60 bundled by the insulating layer 61 are exposed in the inside of the cable holding chamber 22 and the turntable 15.

A cable guide 65 is provided at the first cable connection port 25. The cable guide 65 guides the cable 12 led out through the first cable connection port 25. The cable guide 65 is rotatably supported by the table support portion 16 of the docking tray 10. The cable 12 passes through the cable guide 65.

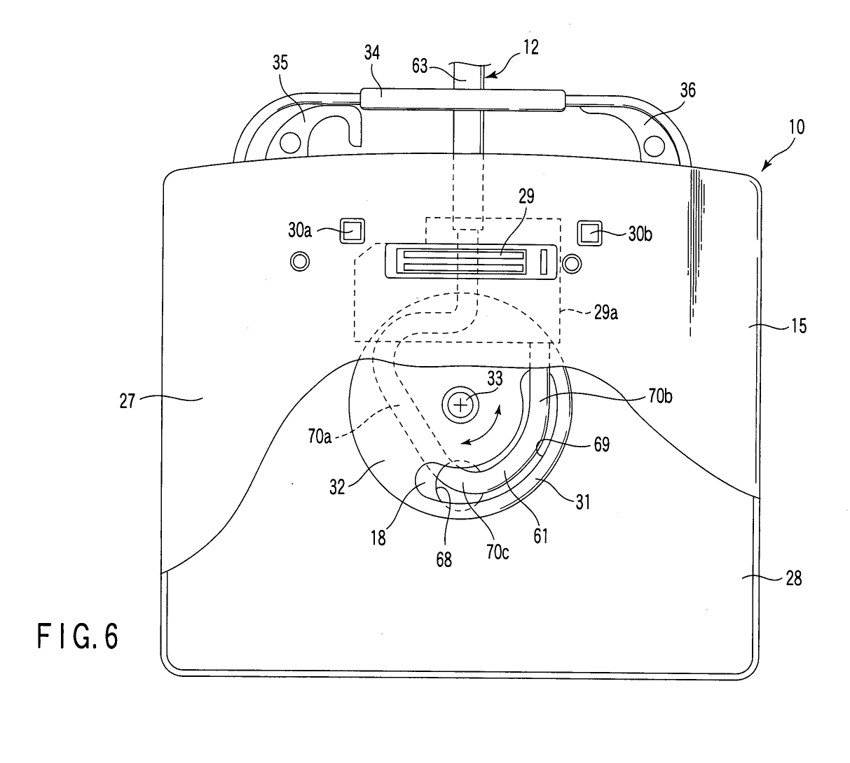

As shown in FIGS. 5 and 6, the cable 12 led out of the first cable connection port 25 into the cable holding chamber 22 is guided to the inside of the turntable 15, through a position aside from the center of rotation of the turntable 15, i.e., the screw 33. The first support wall 18 of the table support portion 16 has a circular first through hole 68, which allows passage of the cable 12. The first through hole 68 is located at a position opposite to the first cable connection port 25 with the screw 33 interposed therebetween, and nearer to the front end of the table support portion 16 than the screw 33. The first through hole 68 is open to the cable holding chamber 22 and faces the second support wall 32 of the turntable 15.

The second support wall 32 of the turntable 15 has a second through hole 69, which allows passage of the cable 12. The second through hole 69 is an elongated opening shape, corresponding to the rotation angle of the turntable 15, and curved along an arc of a circle having its center at the screw 33. The first through hole 68 is located in the range of the opening of the second through hole 69.

In other words, when the turntable 15 is at the first rotation position, the first through hole 68 is located at one end of the second through hole 69. When the turntable 15 is at the second rotation position, the first through hole 68 is located at the other end of the second through hole 69. Therefore, the cable holding chamber 22 of the base 14 communicates with the inside of the turntable 15 via the first and second through holes 68 and 69. The relative position between the first through hole 68 and the second through hole 69 varies in accordance with the rotation position of the turntable 15.

As shown in FIGS. 5 and 6, the cable 12 introduced in the docking tray 10 lies across the cable holding chamber 22 and the turntable 15 through the first and second through holes 68 and 69. More specifically, the cable 12 has a first portion 70a located in the cable holding chamber 22, a second portion 70b located in the turntable 15 and a third portion 70c connecting between the first portion 70a and the second portion 70b. The third portion 70c constitutes the middle portion of the cable 12.

The first portion 70a of the cable 12 is led to the first through hole 68 through a portion under the recess portion 17 of the table support portion 16. As shown in FIG. 6, the second portion 70b of the cable 12 is led from the first through hole 68 to the connector board 29a along the opening shape of the second through hole 69. The third portion 70c of the cable 12 is passed through the first and second through holes 68 and 69 at an angle of inclination with respect to the axis O1 of the screw 33.

The expansion device 2 of the above structure can be used in two modes. In a first mode, as shown in FIG. 1, the docking tray 10 is detached from the docking base 11, and the portable computer 1 is used in the state where it is mounted on the docking tray 10. In a second mode, the docking tray 10 is attached to the docking base 11 and the portable computer 1 is used in the state where it is mounted on the docking tray 10.

When the expansion device 2 is used in the first mode, the docking tray 10, as well as the docking base 11, is placed on the mount surface 13 and nearer to the operator than the docking base 11. Therefore, the cable 12 is led from the front end portion of the docking base 11 to the back end portion of the docking tray 10 on the mount surface 13.

In the second mode, the bottom plate 21 of the base 14 faces the front surface 48 of the tray-supporting portion 41, and the first and second engaging portions 19a, 19b, 20a and 20b at the four corners of the base 14 are engaged with the engaging grooves 51 of the tray receivers 49 and 50. Thus, the cable 12 led out through the first cable connection port 25 of the docking tray 10 is guided into the cable holder 54 through the upper end of the cable introducing port 55. Likewise, the cable 12 led out through the second cable connection port 46 of the docking base 11 is guided into the cable holder 54 through the lower end of the cable introducing port 55.

Both in the first and second modes, the turntable 15 of the docking tray 10 is rotatable between the first rotation position, in which the input surface 7a of the portable computer 1 is in the landscape configuration, and the second rotation position, in which the input surface 7a of the portable computer 1 is in the portrait configuration.

The cable 12 introduced in the docking tray 10 passes through the first and second support walls 18 and 32 at a position aside from the center of rotation of the turntable 15, i.e., the screw 33. In other words, the cable 12 extends across the base 14 and the turntable 15 around the screw 33. Therefore, it is unnecessary to keep a space for the cable 12 to pass between the bottom end of the screw 33 and the bottom plate 21 of the base 14 and between the top end of the screw 33 and the mount surface 27 of the turntable 15.

Thus, the base 14 and the turntable 15 can be thin and compact.

Further, according to the above structure, the second through hole 69 formed in the second support wall 32 is shaped as an arc, which opens in the range corresponding to the rotation angle of the turntable 15. Therefore, the third portion 70c of the cable 12 passing through the first and second through holes 68 and 69 can be routed at an angle of inclination with respect to the axis O1 of the screw 33 as shown in FIG. 8.

As a result, the cable 12, which is thick and stiff because it is formed of a bundle of many signal lines 60, need not be forcefully bent at a connecting portion between the base 14 and the turntable 15. In addition, the cable 12 need not be largely projected in the axial direction of the screw 33 at the aforementioned connecting portion. Therefore, the cable 12 does not extend in the axial direction of the screw 33 at the connecting portion; consequently, the connecting portion is much thinner than the conventional art.

In the above embodiment, the second through hole of the turntable is arc-shaped and the cable is arranged at an angle of inclination with respect to the axis of the screw. However, the present invention is not limited to this structure. For example, the first through hole of the base may be arc-shaped, while the second through hole of the turntable may be circular. Alternatively, both the first and second through holes may be arc-shaped.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A supporting device comprising:
a first housing;
a second housing, which overlies the first housing;
a hinge shaft, which connects the first housing and the second housing rotatably relative to each other; and
a cable passing through a connecting portion between the first housing and the second housing,
wherein the first housing and the second housing respectively have through holes, which communicate with each other at a position aside from the hinge shaft, and the cable passes through the through holes across the first housing and the second housing.

2. The supporting device according to claim 1, wherein at least one of the through hole of the first housing and the through hole of the second housing has an opening shape curved along an arc of a circle having its center at the hinge shaft.

3. The supporting device according to claim 1, wherein the cable has a middle portion spanning the first housing and the second housing through the through holes, and the middle portion is inclined with respect to an axis of the hinge shaft.

4. A supporting device comprising:
a first housing, which has a first support wall;
a second housing, which has a second support wall facing the first support wall;
a hinge shaft, which connects the first housing and the second housing rotatably relative to each other; and
a cable passing through a connecting portion between the first housing and the second housing,
wherein the hinge shaft extends across the first support wall and the second support wall, and the cable passes through the first and second support walls at a position aside from the hinge shaft.

5. The supporting device according to claim 4, wherein the first support wall and the second support wall respectively have through holes, which communicate with each other at a position aside from the hinge shaft, and at least one of the through hole of the first housing and the through hole of the second housing has an opening shape curved along an arc of a circle having its center at the hinge shaft.

6. A supporting device comprising:
a first housing;
a second housing, which overlies the first housing;
a hinge shaft, which connects the first housing and the second housing rotatably relative to each other; and
a cable passing through a connecting portion between the first housing and the second housing,
wherein the first housing and the second housing respectively have through holes, which communicate with each other at a position aside from the hinge shaft; the cable has a first portion located inside the first housing, a second portion located inside the second housing and a third portion connecting the first portion and the second portion; and the third portion of the cable passes through the through holes across the first housing and the second housing.

7. The supporting device according to claim 6, wherein the third portion of the cable is inclined with respect to an axis of the hinge shaft.

8. The supporting device according to claim 6, wherein at least one of the through hole of the first housing and the through hole of the second housing has an opening shape curved along an arc of a circle having its center at the hinge shaft.
